(19) United States
(12) Patent Application Publication
(10) Pub. No.: US 2006/0209530 A1
(43) Pub. Date: Sep. 21, 2006

(54) Lamp with personal audio player interface and speaker system

(76) Inventor: Lee Schaak, Dix Hills, NY (US)

Correspondence Address: DARBY & DARBY P.C., P. O. BOX 5257, NEW YORK, NY, 10150-5257, US

(21) Appl. No.: 11/450,523

(22) Filed: Jun. 9, 2006

Related U.S. Application Data
(60) Provisional application No. 60/808,829, filed on May 25, 2006.

(51) Int. Cl. H04M 1/22

(52) U.S. Cl. 362/86; 362/253; 362/414

(57) ABSTRACT

A desk lamp includes a docking station for media devices. The lamp has a support that houses a speaker and a docking structure for receiving the media device. An electrical connector and associated cable connect an output of the media player to the speaker. The desk lamp further includes a neck for coupling a terminal housing to the support. A bulb socket is attached to the terminal housing to receive a light bulb. A power cord electrically couples the bulb socket to a battery compartment or to an electrical plug. The lamp may in addition include a transformer and a charging circuit that are electrically coupled to contacts in the docking structure for providing power to the media device. Alternatively, the lamp may include a second socket at an exterior surface of the support for connecting to a media device compatible cable to receive power.

### CROSS-REFERENCE TO RELATED APPLICATION

The present application claims the benefit under 35 U.S.C. § 119(e) of U.S. Provisional Application No. 60/808,829, filed on May 25, 2006, and entitled “Lamp With Personal Audio Player Interface And Speaker System.” U.S. Provisional Application No. 60/808,829 is hereby incorporated by reference in its entirety.

### FIELD OF INVENTION

The present invention relates to a lighting apparatus, and more particularly, to an improved desk lamp having a docking station for holding media players, and having a speaker assembly for outputting audio files contained in the media player.

### BACKGROUND OF THE INVENTION

Conventional lighting apparatuses are useful as sources of electrically-generated light, and are also popular for decorative purposes. Standard chargers and docking stations for media players are usually placed on a desk which often has as a desk lamp placed thereon. This can make the desk crowded. There is a continuing need for improved features for connecting or coupling media players, such as MP3 music players, to one or more external input/output devices while minimizing desk space and avoiding clutter from associated wired connections.

Thus, it would be desirable to provide a desk lamp having an integrated speaker assembly for media players in order to eliminate the need for having separate media player docking station and lamp apparatus, in order to save desk space and to reduce unnecessary clutter from conventional media player wired data and power connections.

### SUMMARY OF THE INVENTION

The present invention is for desk lamp including a docking station for media devices. The lamp has a support or base which houses a speaker, the support having at least a mount surface, and a docking structure for receiving the media device. An electrical connector and associated cable are provided for electrically connecting an output of the media player to the speaker. The lamp further includes a neck having a first portion coupled to the support mount surface and a second portion remote from the first portion. A terminal housing is fixedly disposed relative to the neck second portion, a bulb socket including a seat portion is attached to the terminal housing, and a shell portion of the terminal housing is shaped to receive the base of a light bulb. The lamp in addition includes a power cord including a pair of insulated conductive cord members, electrically coupled at one end to the bulb socket and at another end to a battery compartment or to an electrical plug.

The lamp support may also house a transformer electrically coupled to the power cord in parallel to the bulb socket. In this case, the docking structure provides one or more electrical contacts for connecting to a power input terminal of the media player, and the support houses a charging circuit electrically connected between the electrical contact and the transformer.

Alternatively, the lamp may include a second socket disposed on the support, the socket having a first end directed internally of the support and coupled to the speaker and a second end positioned externally on the support for connecting to a media device compatible cable.

These and other aspects, features, steps and advantages can be further appreciated from the accompanying drawing Figures and description of certain illustrative embodiments.

### BRIEF DESCRIPTION OF THE DRAWINGS

FIGS. 1-5 provide perspective views of lamps that are in accordance principles of the present invention; and

FIG. 6 is a schematic drawing of the lamp, in accordance with principles of the present invention.

### DETAILED DESCRIPTION OF ILLUSTRATED EMBODIMENTS

The following detailed description illustrates the invention by way of example, and not by way of limitation. This description will clearly enable one skilled in the art to make and use the invention, and describes several embodiments, adaptations, variations, alternatives and uses of the invention, including what we presently believe is the best mode of carrying out the invention. It should be understood that any feature described in one embodiment or arrangement can be equally applied to any other embodiment or arrangement without departing from the spirit of the present invention.

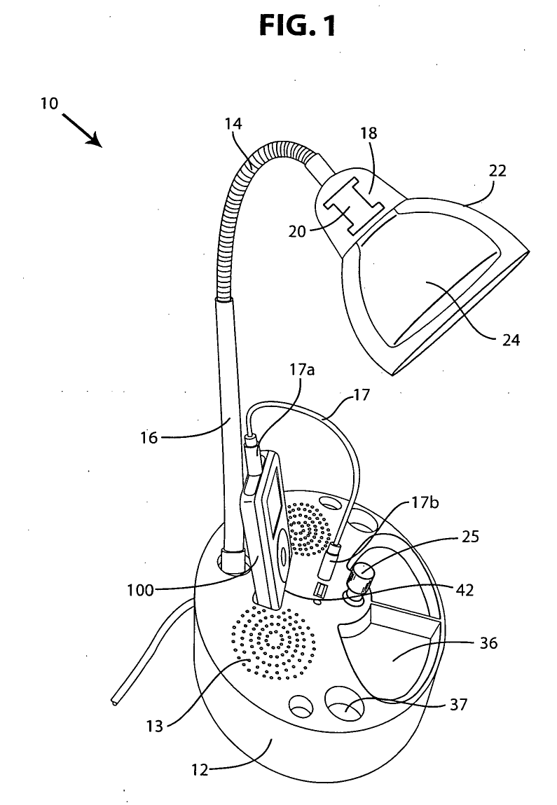

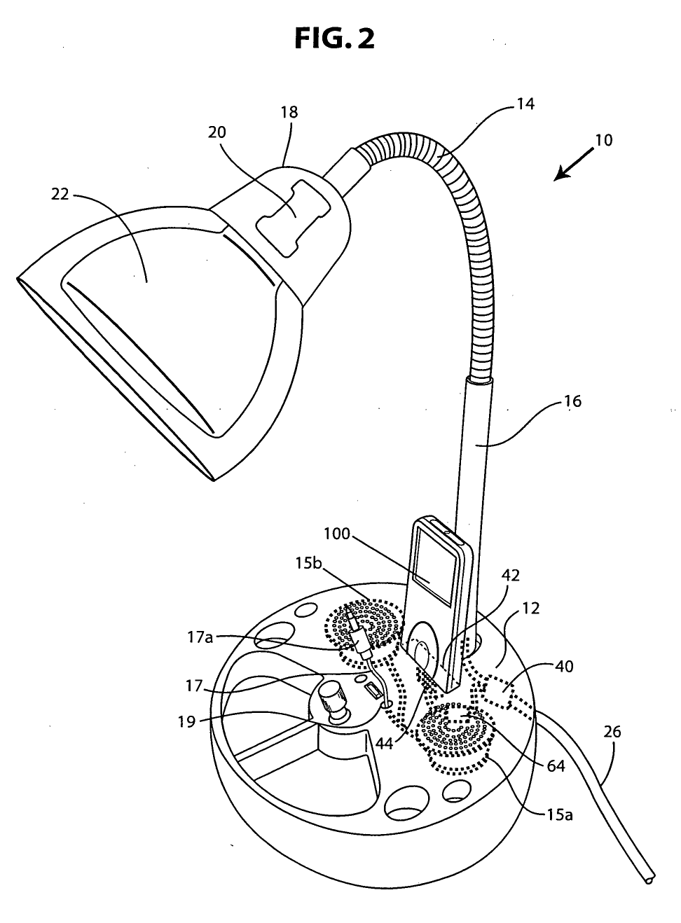

By way of overview and introduction, described is a lighting apparatus having a docking station for charging a media player and a speaker assembly for outputting audio files stored on the media player. Referring to FIGS. 1 and 2, a perspective view of a lighting apparatus 10 constructed in accordance with the invention is shown. The lighting apparatus 10 includes a support 12 to which is connected a flexible neck 14. The flexible neck 14 may have a non-flexible portion 16 that extends from support 12, or alternatively may be sized to receive a non-flexible stem that is integral with and extends from support 12. At a distal end of the neck 14 remote from the support 12 is a terminal housing 18, to which is mounted a bulb socket 20 and a lamp shade 22

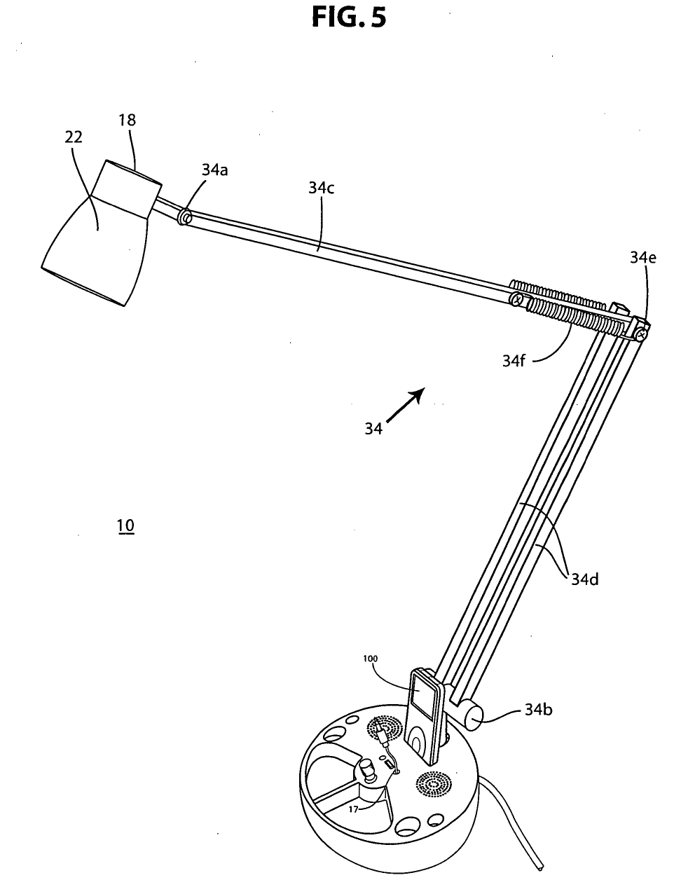

As an alternative to the flexible neck 14 illustrated in FIGS. 1 and 2, the lighting apparatus 10 may alternatively be fitted with an articulable neck 34 as illustrated in FIG. 5. As illustrated in FIG. 5, the articulable neck 34 comprises a jointed connector 34a, a jointed connector 34b and neck assembly 34c, 34d, 34e and 34f. Jointed connector 34a interconnects terminal housing 18 to upper neck member 34c, in a manner allowing for rotational movement of terminal 18 in at least one plane relative to upper member 34c. Jointed connector 34b interconnects support 12 to lower neck members 34d in a manner allowing for rotational movement of lower neck members 34d in at least one plane relative to support 12. Preferably, connector 34b is additionally rotatable in support 12 to allow for rotational movement of lower neck members 34d in an additional plane that is orthogonal to the one plane relative to support 12.

Jointed connector 34e interconnects upper neck member 34c to lower neck members 34d in a manner allowing for rotational movement of upper neck members 34c in at least one plane relative to lower neck members 34d. A selected position of upper neck member 34c in relation to lower neck members 34d may be maintained by a spring 34f, which resists additional movement due to the application of gravitational force on upper neck member 34c and terminal housing. Alternatively, jointed connector 34e may be configured so that frictional forces within the jointed connector 34e resist such movement. Connectors 34a and 34b may be similarly connected. In this manner, articulable neck 34 enables the lamp assembly 18, 22 to be movably positioned during use, and to be retractably folded after use for compact storage

It should be understood that the articulable neck 34 may alternatively be configured with a single neck member that interconnects jointed connectors 34a and 34b. The single neck member may either fixed, or assembled in telescoping sections to permit the neck 34 to be collapsed from an extended position for compact storage.

The lamp shade 22 can have a variety of conventional configurations, and adds an eye-pleasing effect to the lighting assembly. For example, the lamp shade 22 may be configured as a globe, a shade, or any other suitable surrounding for a light source 24, as is known in the art.

Returning to FIGS. 1 and 2, it can be seen that support 12 of lighting apparatus 10 includes sound emitting slots 13. Speakers 15a and 15b are mounted within support 12 below respective sound emitting slots 13. It should be understood that any number of sound emitting slots 13 and speakers 15 greater than or equal to one each are contemplated as being within the scope of the present invention. It is also contemplated as being within the scope of the present invention that speakers 15 may alternatively be mounted in one or more separate speaker enclosures that may be extendibly positioned from the support 12, or may be alternatively positioned on the support 12 in a fixed manner or in a manner that allows a sound emission direction of the speakers 15 to be adjusted relative to the support 12.

Support 12 may also conveniently feature one or more tray cavities 36 for placement and retention of small, miscellaneous desktop items (for example, paper clips and the like). In addition, support 12 may feature one or more ports 37 that contribute to the acoustic performance of speakers 15a, 15b, or provide for dissipation of heat generated by electrical circuitry contained within support 12. Support 12 may be readily fabricated from one or more sheet metal stampings, or alternatively, from one or more plastic components fabricated for example by injection molding. For example, support 12 may be fabricated as a transparent plastic housing. Alternatively, support 12 may be fabricated as a translucent plastic housing.

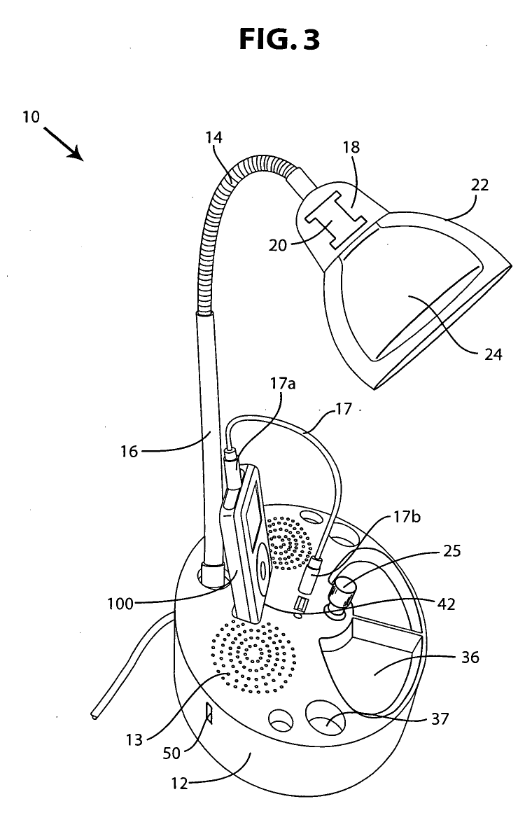

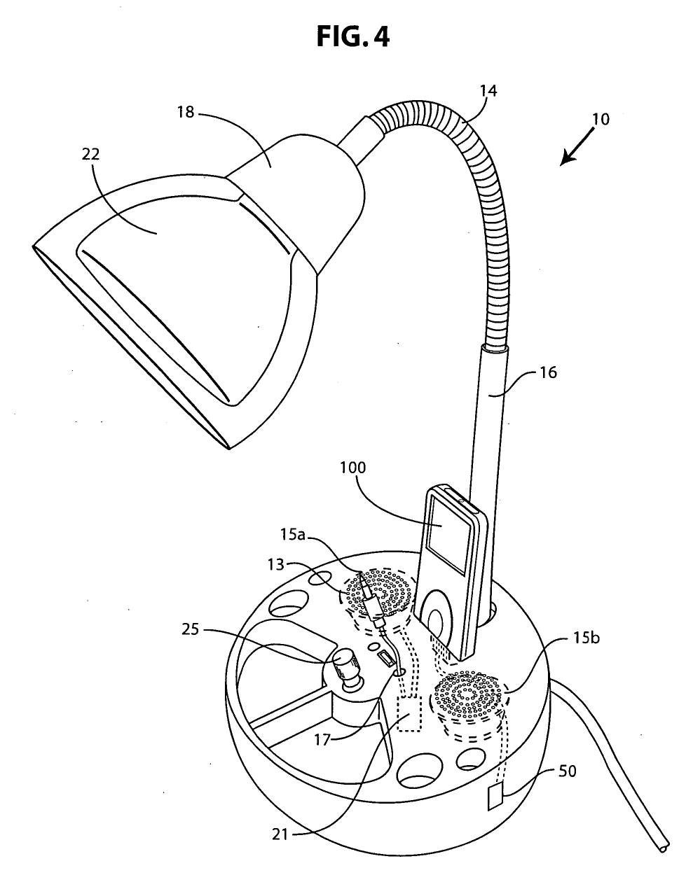

As illustrated in FIGS. 1 and 2, an audio output cable 17 is electrically connected via a plug 17a at one end to each of speakers 15a and 15b. As illustrated in FIGS. 2 and 4, the other end of audio cable 17 may be fed through an orifice 19 in support 12 and be operable to connect, for example, to the headset jack or other audio output terminal of media player 100 as indicated. Alternatively, as illustrated in FIGS. 1 and 3, the orifice 19 may house a connector (not shown) for plugably connecting to a plug 17b of output cable 17.

In combination with a recess 42 that receives and positions the media player for operation, audio output cable 17 and speakers 15a and 15b enable lighting apparatus 10 to provide both docking and audio output functions for a the media player, in addition to functioning as a fully operable desk lamp. In accordance with an alternative arrangement illustrated for example by FIG. 4, a conventional audio amplifier circuit 21 may also be included within support 12. The audio amplifier circuit 21 is connected between audio output cable 17 and speakers 15a and 15b, and is operable to provide amplification of audio output directed from media player 100 to speakers 15a and 15b. One or more controls, such as turn-knob 25, can be located on support 12 for providing one or more of volume control, sound equalization, right and left speaker control, and light switching functions.

Power cord 26 may for example be composed of lamp cord, include an electrical power plug 28 (not shown) at one end, and be conductively coupled at another end to the bulb socket 20 either directly or through a switch 30 (not shown). The switch 30 can for example be located along the lamp cord, be integral with the bulb socket 20, be mounted to the terminal housing, or be mounted to another portion of the lighting apparatus 10 including support 12. The mechanism for switch 30 can, for example, be implemented as a conventional rotary switch, a push/pull switch, a microswitch or a capacitive switch. The light source 24 (e.g., incandescent bulb, halogen lamp, fluorescent bulb, or one or more LEDs) is mounted in the bulb socket 20 and positioned in a plurality of positions relative to the support 12 by arrangement of the flexible neck 14.

FIG. 1 illustrates an embodiment of lighting apparatus 10 which includes a non-flexible neck portion 16 that extends from support 12 that, in cooperation with support 12, is coupled to and elevates flexible neck 14 and the lamp assembly. Support 12 has a mass which is sufficient to overcome any turning moments created when the light source 24 is cantilevered out beyond an edge of the support 12, thus preventing the lighting assembly 10 from tipping.

The flexible neck 14 permits users to position the light source 24 over a wide range of positions relative to the support 12. Multiple lamp assemblies supported by multiple necks 14 are also fully contemplated within the scope of the present invention. It should be pointed out that flexible neck 14 must have a resiliency which is sufficient to support a load imposed by the terminal housing 18, the light bulb socket 20 and the lamp shade 22. In particular, the flexible neck 14 may further demonstrate its resiliency by having the characteristic capability of recovering its shape after deformation. With this resiliency, a user can freely position a light source 24 relative to the support 12. More particularly, a load defined by the terminal housing 18, the light bulb socket 20, and the lamp shade 22 must be insufficient to cause the flexible neck 14 to sag or otherwise change its position from that selected by the user.

Referring to FIG. 2, a transformer 40 is provided within the support 12. The transformer 40 is electrically coupled to the power cord 26 and is connected in parallel to the bulb socket 20. The on-off switch 30 (not shown) is also be electrically coupled to the transformer 40.

As illustrated in FIG. 2, the recess 42 is provided on the top surface of the support 12 for receiving the media player 100. A plurality of contacts 44 are formed at the base or on a wall of the recess 42. In accordance with one arrangement of the present invention and with reference to FIG. 2, a circuit board 64 is provided inside the support 12. A charging circuit of the circuit board 64 is electrically interconnected to contacts 44, and to the transformer 40 in order to obtain, for example, a DC voltage generated by the charging circuit. As such, rated voltage can be supplied to the transformer 40, lowered by the transformer 40, and then sent to the charging circuit of circuit board 44 for DC conversion. This DC voltage may be fed to contacts 44 to charge a discharged, rechargeable battery within media device 100 as detailed below.

Recess 42 is shaped to snugly receive a lower portion of media device 100 so as to align or matingly couple electrical contacts 46 on the media device 100 with contacts 44 of support 12, and thereby act as a socket for media device 100. Contact between contacts 44 of support 12 and contacts on media device 100 (not shown) for example may permit a rechargeable battery housed wholly within media device 100 to charge. Contacts 44 and media device 100 contacts are adapted to matingly couple with each other so that DC voltage can be supplied to the rechargeable battery of media device 100 for charging through the coupled contacts 44 and media device 100 contacts. In addition, if the media player 100 includes audio output contacts in proximity to the charging contacts, ones of coupled contacts 44 may be connected to speakers 15a and 15b via an internal cable (not shown) as an alternative to audio output cable 17.

In accordance with an alternative arrangement of the present invention and with reference to FIG. 4, a charging circuit is excluded from lighting apparatus 10, and contacts 44 are electrically connected to a socket 50 disposed on an exterior surface of support 12. Connection between contacts 44 and socket 50 are provided through internally disposed cable 51. Socket 50 is adapted to interface with the charging and/or data cable associated with media player 100. For example, an IPod media player sold by Apple Inc. typically employs a cable to connect the IPod to a computer via the computer's USB port. This cable has a custom pinout on one end which connects to the IPod device and a USB connection on the other end which mates with the USB port on a computer. The cable allows both transmission of data between the computer and the IPod and charging of the IPod's internal battery through the USB port on the computer. Socket 50 on support 12 allows lighting apparatus 10 to be adapted for use with standard media player charging cables. Accordingly, socket 50 is configured to match the pinout on media player 100 for which recess 42 of lighting apparatus 10 is designed to accept. Thus, in the example above, when socket 50 is configured to match the pinout of on an IPod media device, the IPod is be placed in recess 42 and a standard IPod cable is connected between socket 50 and the USB port of a computer. It should be apparent that, in accordance with this arrangement, cable 51 (internal to support 12) functions as a bridge between the media device and it's customary cable for providing external device compatibility. Charging of media device 100 can thus be provided through the media device's standard cable connection.

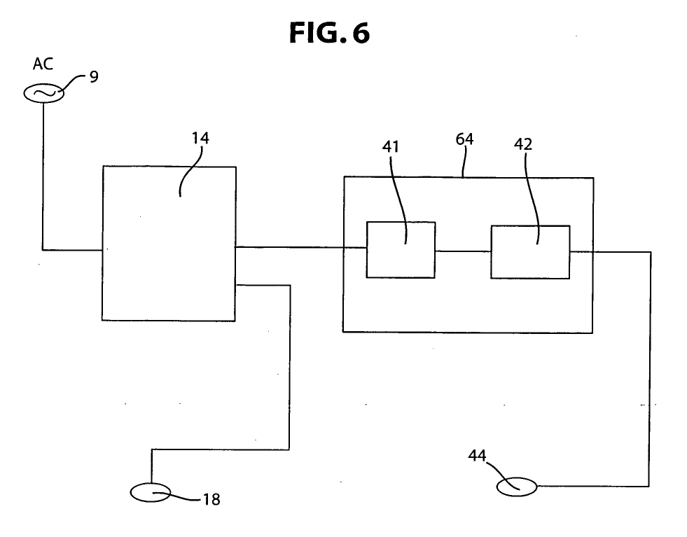

Referring to FIG. 6, there is shown a schematic drawing of the lamp and charging circuit of the desk lamp. The transformer 14 is electrically coupled to a commercial AC power source 9 (via cord 26 of FIGS. 1-4), and to charging circuit of the circuit board 64, so that rated AC voltage produced by the commercial AC power source 9 can be lowered by the transformer 14. The transformer 14 may also be electrically coupled to the terminal 18 to provide a second lowered voltage for operating the lamp (for example, to provide a dimming function via a variable tap or other conventional means). The charging circuit comprises a conventional rectifier 41 electrically coupled to AC output of the transformer 14 for converting AC into DC, and a conventional stabilizer 42 electrically coupled to output of the rectifier 41 for smoothing DC voltage. The stable charging voltage is then fed to contacts 44 for charging a battery of media device 100 in recess 42.

Thus, while there have been shown, described, and pointed out fundamental novel features of the invention as applied to several embodiments, it will be understood that various omissions, substitutions, and changes in the form and details of the devices illustrated, and in their operation, may be made by those skilled in the art without departing from the spirit and scope of the invention. Substitutions of elements from one described embodiment to another are also fully intended and contemplated. It is also to be understood that the drawings are not necessarily drawn to scale, but that they are merely conceptual in nature. The invention is defined solely with regard to the claims appended hereto, and equivalents of the recitations therein.

I claim:

1. A lighting apparatus comprising:
a support housing a speaker, the support having at least a mount surface and a docking structure for receiving a media device;
connecting means for electrically coupling an audio output of the media device to the speaker;
a neck having a first portion coupled to the support mount surface and a second portion remote from the first portion;
a terminal housing affixed to the second portion of the neck;
a bulb socket including a seat portion attached to the terminal housing, and a shell portion shaped to receive a base of a light bulb; and
a power cord coupled to the bulb socket and to an electrical plug.

2. The lighting apparatus of claim 1 wherein the docking structure further includes one or more electrical contacts.

3. The lighting apparatus of claim 2 wherein the support houses a transformer electrically coupled to the power cord.

4. The lighting apparatus of claim 3 wherein the support houses a charging circuit electrically connected between the one or more electrical contacts and the transformer.

5. The lighting apparatus of claim 2 further comprising a second socket disposed on the support, the second socket having a first end that is directed internally of the support and is electrically coupled to the one or more electrical contacts, and having a second end that is accessible at an external surface of the support for electrical coupling to a media device compatible cable.

6. The lighting apparatus of claim 4 wherein the docking structure is shaped to receive the media device in a position for electrically coupling the one or more electrical contacts to one or more contacts of the media device.

7. The lighting apparatus of claim 1 wherein the neck comprises a jointed, articulatable tube.

8. The lighting apparatus of claim 1 wherein the neck comprises one or more neck members, the one or more neck members being coupled to each of the support and the terminal housing via a rotatable joint.

9. The lighting apparatus of claim 1, wherein the neck comprises at least two neck members, and one of the at least two neck members is slidingly coupled over a second neck member to form a telescoping assembly.

10. The lighting apparatus of claim 1, further comprising:
a switch that is electrically coupled to the power cord for switchably directing power to the bulb socket;
wherein the switch is operable by one of a push, a pull, a toggle, and a rotary action.

11. The lighting apparatus of claim 1, wherein the connecting means for electrically coupling the audio output of the media device to the speaker includes an output cable electrically coupled to the speaker, passing from an interior cavity of the support through an exterior surface of the support, and terminating beyond the exterior surface at an electrical connector that is adapted to be electrically coupled to an audio output terminal of the media device.

12. The lighting apparatus of claim 11, wherein the electrical connector is fixedly mounted at the exterior surface of the support, and is adapted to be further electrically coupled via an intermediate output cable to the audio output terminal of the media device.

13. The lighting apparatus of claim 2, wherein the connecting means for electrically coupling the audio output of the media device to the speaker includes an output cable coupling the speaker to one or more of the one or more electrical contacts.

14. The lighting apparatus of claim 1, wherein the support comprises a sheet metal stamping.

15. The lighting apparatus of claim 1, wherein the support comprises an injection-molded plastic.

16. The lighting apparatus of claim 15, wherein the injection-molded plastic is one of a transparent plastic or a translucent plastic.

17. The lighting apparatus of claim 1, wherein the speaker is housed in an auxiliary enclosure and may be removably positioned with reference to the support.

18. The lighting apparatus of claim 1, wherein the speaker is housed in an auxiliary enclosure and may be adjustably positioned with reference to the support.

19. The lighting apparatus of claim 1, wherein the support has at least one port on the mount surface positioned away from the speaker and providing ingress into an interior of the support.

20. The lighting apparatus of claim 1, wherein the support has at least one tray depressedly positioned in the mount surface.

21. The lighting apparatus of claim 5, wherein the speaker is housed in an auxiliary enclosure and may be removably positioned with reference to the support.

22. The lighting apparatus of claim 5, wherein the speaker is housed in an auxiliary enclosure and may be adjustably positioned with reference to the support.

23. The lighting apparatus of claim 11, wherein the speaker is housed in an auxiliary enclosure and may be removably positioned with reference to the support.

24. The lighting apparatus of claim 11, wherein the speaker is housed in an auxiliary enclosure and may be adjustably positioned with reference to the support.

25. The lighting apparatus of claim 12, wherein the speaker is housed in an auxiliary enclosure and may be removably positioned with reference to the support.

26. The lighting apparatus of claim 12, wherein the speaker is housed in an auxiliary enclosure and may be adjustably positioned with reference to the support.

27. The lighting apparatus of claim 19, wherein the speaker is housed in an auxiliary enclosure and may be removably positioned with reference to the support.

28. The lighting apparatus of claim 20, wherein the speaker is housed in an auxiliary enclosure and may be adjustably positioned with reference to the support.

29. The lighting apparatus of claim 5, wherein the connecting means for electrically coupling the audio output of the media device to the speaker includes an output cable electrically coupled to the speaker, passing from an interior cavity of the support through an exterior surface of the support, and terminating beyond the exterior surface at an electrical connector that is adapted to be electrically coupled to an audio output terminal of the media device.

30. The lighting apparatus of claim 21, wherein the connecting means for electrically coupling the audio output of the media device to the speaker includes an output cable electrically coupled to the speaker, passing from an interior cavity of the support through an exterior surface of the support, and terminating beyond the exterior surface at an electrical connector that is adapted to be electrically coupled to an audio output terminal of the media device.

31. The lighting apparatus of claim 22, wherein the connecting means for electrically coupling the audio output of the media device to the speaker includes an output cable electrically coupled to the speaker, passing from an interior cavity of the support through an exterior surface of the support, and terminating beyond the exterior surface at an electrical connector that is adapted to be electrically coupled to an audio output terminal of the media device.

32. The lighting apparatus of claim 29, wherein the electrical connector is fixedly mounted at the exterior surface of the support, and is adapted to be further electrically coupled via an intermediate output cable to the audio output terminal of the media device.

33. The lighting apparatus of claim 30, wherein the electrical connector is fixedly mounted at the exterior surface of the support, and is adapted to be further electrically coupled via an intermediate output cable to the audio output terminal of the media device.

34. The lighting apparatus of claim 31, wherein the electrical connector is fixedly mounted at the exterior surface of the support, and is adapted to be further electrically coupled via an intermediate output cable to the audio output terminal of the media device.
